(19) United States
(12) Patent Application Publication
(10) Pub. No.: US 2024/0182078 A1
(43) Pub. Date: Jun. 6, 2024

(54) SYSTEM AND METHOD FOR RISK-BIASED TRAJECTORY FORECASTING

(71) Applicant: TOYOTA RESEARCH INSTITUTE, INC., Los Altos, CA (US)

(72) Inventors: Haruki NISHIMURA, Sunnyvale, CA (US); Jean MERCAT, Mountain View, CA (US); Rowan Thomas MCALLISTER, San Jose, CA (US); Adrien David GAIDON, Mountain View, CA (US)

(73) Assignees: TOYOTA RESEARCH INSTITUTE, INC., Los Altos, CA (US); TOYOTA JIDOSHA KABUSHIKI KAISHA, Aichi-Ken (JP)

(21) Appl. No.: 18/071,881

(22) Filed: Nov. 30, 2022

(51) Int. Cl. B60W 60/00; G06N 3/09

(52) U.S. Cl. CPC B60W 60/0027; G06N 3/09; G05D 1/0214

(57) ABSTRACT

A method of forecasting risk-biased trajectories of agents surrounding an ego vehicle is described. The method includes sampling a risk-neutral latent space generated by a trained encoder of a generative network based on past surrounding agent trajectories. The method also includes predicting, based on the sampling of the risk-neutral latent space, risk-neutral future surrounding agent trajectories using a trained decoder of the generative network. The method further includes sampling a risk-biased latent space distribution generated by a trained, risk-aware encoder of the generative network based on past trajectories of the ego vehicle and a risk-sensitivity. The method also includes predicting, based on the sampling of the risk-biased latent space distribution, risk-biased future surrounding agent trajectories using the trained decoder of the generative network.

### BACKGROUND

### Field

Certain aspects of the present disclosure generally relate to autonomous vehicle technology and, more particularly, to risk-biased trajectory forecasting for safe human-robot interaction.

### Background

Autonomous agents rely on machine vision for sensing a surrounding environment by analyzing areas of interest in a scene from images of the surrounding environment. Although scientists spent decades studying the human visual system, a solution for realizing equivalent machine vision remains elusive, but is a goal for enabling truly autonomous agents. Machine vision, however, is distinct from the field of digital image processing. In particular, machine vision involves recovering a three-dimensional (3D) structure of the world from images and using the 3D structure for fully understanding a scene. That is, machine vision strives to provide a high-level understanding of a surrounding environment, as performed by the human visual system.

Autonomous agents, such as driverless cars and robots, quickly evolved and are a reality in this decade. Because autonomous agents interact with humans, however, many critical concerns arise. For example, one critical concern is how to design vehicle control of an autonomous vehicle using machine learning. Unfortunately, vehicle planning and control by machine learning is less effective in complicated traffic environments involving complex interactions between vehicles (e.g., in situations where an ego vehicle maneuvers through roadway traffic and intersections).

Robust planning in interactive scenarios involves predicting the uncertain future to make risk-aware decisions. Unfortunately, due to long-tail safety-critical events, the risk is often under-estimated by finite-sampling approximations of probabilistic motion forecasts. This can lead to overconfident and unsafe autonomous agent behavior, even with robust planners. A robust planner that learns a risk-biased distribution over trajectories to make risk-aware trajectory forecasting is desired.

### SUMMARY

A method of forecasting risk-biased trajectories of agents surrounding an ego vehicle is described. The method includes sampling a risk-neutral latent space generated by a trained encoder of a generative network based on past surrounding agent trajectories. The method also includes predicting, based on the sampling of the risk-neutral latent space, risk-neutral future surrounding agent trajectories using a trained decoder of the generative network. The method further includes sampling a risk-biased latent space distribution generated by a trained, risk-aware encoder of the generative network based on past trajectories of the ego vehicle and a risk-sensitivity. The method also includes predicting, based on the sampling of the risk-biased latent space distribution, risk-biased future surrounding agent trajectories using the trained decoder of the generative network.

A non-transitory computer-readable medium having program code recorded thereon for forecasting risk-biased trajectories of agents surrounding an ego vehicle is described. The program code is executed by a processor. The non-transitory computer-readable medium includes program code to sample a risk-neutral latent space generated by a trained encoder of a generative network based on past surrounding agent trajectories. The non-transitory computer-readable medium also includes program code to predict, based on the sampling of the risk-neutral latent space, risk-neutral future surrounding agent trajectories using a trained decoder of the generative network. The non-transitory computer-readable medium further includes program code to sample a risk-biased latent space distribution generated by a trained, risk-aware encoder of the generative network based on past trajectories of the ego vehicle and a risk-sensitivity. The non-transitory computer-readable medium also includes program code to predict, based on the sampling of the risk-biased latent space distribution, risk-biased future surrounding agent trajectories using the trained decoder of the generative network.

A system for forecasting risk-biased trajectories of agents surrounding an ego vehicle is described. The system includes a risk-neutral latent space sampling module to sample a risk-neutral latent space generated by a trained encoder of a generative network based on past surrounding agent trajectories. The system also includes a risk-neutral trajectory prediction module to predict, based on the sampling of the risk-neutral latent space, risk-neutral future surrounding agent trajectories using a trained decoder of the generative network. The system further includes a risk-biased latent space sampling module to sample a risk-biased latent space distribution generated by a trained, risk-aware encoder of the generative network based on past trajectories of the ego vehicle and a risk-sensitivity. The system also includes a risk-biased trajectory prediction module to predict, based on the sampling of the risk-biased latent space distribution, risk-biased future surrounding agent trajectories using the trained decoder of the generative network.

This has outlined, rather broadly, the features and technical advantages of the present disclosure in order that the detailed description that follows may be better understood. Additional features and advantages of the present disclosure will be described below. It should be appreciated by those skilled in the art that the present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC) for a risk-biased trajectory predictor system, in accordance with aspects of the present disclosure.

FIG. 2 is a block diagram illustrating a software architecture that may modularize artificial intelligence (AI) functions for risk-biased trajectory prediction, according to aspects of the present disclosure.

FIG. 3 is a diagram illustrating an example of a hardware implementation for a risk-biased trajectory predictor system, according to aspects of the present disclosure.

FIGS. 4A and 4B are block diagrams illustrating an example of a vehicle having a risk-biased trajectory predictor in an environment, in accordance with various aspects of the present disclosure.

FIG. 5 is a diagram illustrating an overview of a roadway environment, including an ego vehicle having a risk-biased trajectory predictor, according to aspects of the present disclosure.

FIG. 6 is a diagram further illustrating the risk-biased trajectory predictor system of FIG. 3, according to aspects of the present disclosure.

FIG. 7 is a flowchart illustrating a method for forecasting risk-biased trajectories of agents surrounding an ego vehicle, according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure disclosed may be embodied by one or more elements of a claim.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be broadly applicable to different technologies, system configurations, networks and protocols, some of which are illustrated by way of example in the figures and in the following description of the preferred aspects. The detailed description and drawings are merely illustrative of the present disclosure, rather than limiting the scope of the present disclosure being defined by the appended claims and equivalents thereof.

In safety-critical and interactive control tasks, such as autonomous driving, an autonomous agent accounts for uncertainty of a future motion of surrounding humans. Contemporary approaches to safe human-agent interaction decompose the decision-making pipeline into prediction and planning modules. A prediction module, often learned from data, first produces likely future trajectories of surrounding agents, which are then consumed by a planning module for computing safe agent actions. Coupling prediction with risk-sensitive planning for enhanced safety may be performed, in which the planner computes and minimizes a risk measure of a planned trajectory based on probabilistic forecasts of human motion from a data-driven predictor. A risk measure may be a function that maps a cost distribution to a deterministic real number, which lies between an expected cost and a worst-case cost.

Although combining data-driven forecasting and risk-sensitive planning may be effective, this approach has several limitations. First, accurate risk evaluation of candidate agent plans remains challenging due to inaccurate characterization of uncertainty in human behavior and finite-sampling from the predictor. Although some existing methods promoting diversity of prediction may alleviate this issue, they are not explicitly designed for reliable risk estimation specified for agent planning. Second, endowing an existing planner with risk-sensitivity often involves non-trivial modifications to its internal optimization algorithm because the process of optimization can differ significantly between risk-neutral and risk-sensitive planning. This modification can be problematic, if, for example, an autonomy stack already has a dedicated and complex (risk-neutral) planner in use and cannot easily modify its internal optimization algorithms.

To address the above limitations, some aspects of the present disclosure consider risk within a predictor rather than the planner of an autonomous agent. The aspects of the present disclosure present a risk-biased trajectory forecasting framework, which provides a general approach to making a generative trajectory forecasting model risk-aware. In some aspects of the present disclosure, a disclosed method augments a pre-trained generative model with an additional encoding process. This modification changes the output of the prediction so that it purposefully and deliberately over-estimates the probability of dangerous trajectories. This “pessimistic” forecasting model gives distributional robustness to the planner against potential inaccuracies of the human behavior model, according to some aspects of the present disclosure.

Some aspects of the present disclosure achieve a pessimistic, risk-biased distribution using a novel prediction loss. This shifts the computational burden of drawing many prediction samples that capture rare events from online deployment to offline prediction training. The planner can still obtain an accurate estimate of the risk measure in real-time during deployment with a reduced amount of prediction samples specified from the biased distribution. Furthermore, this approach also eliminates modifications to the planner's optimization algorithm. These aspects of the present disclosure can achieve enhanced safety by simply replacing a conventional probabilistic motion forecaster with the proposed risk-biased model, while still using the same existing risk-neutral planner. This capability is intended for use in robotic applications, in which misestimating of risk could lead to injury, including autonomous vehicles and home robots that operate safely in close proximity to humans.

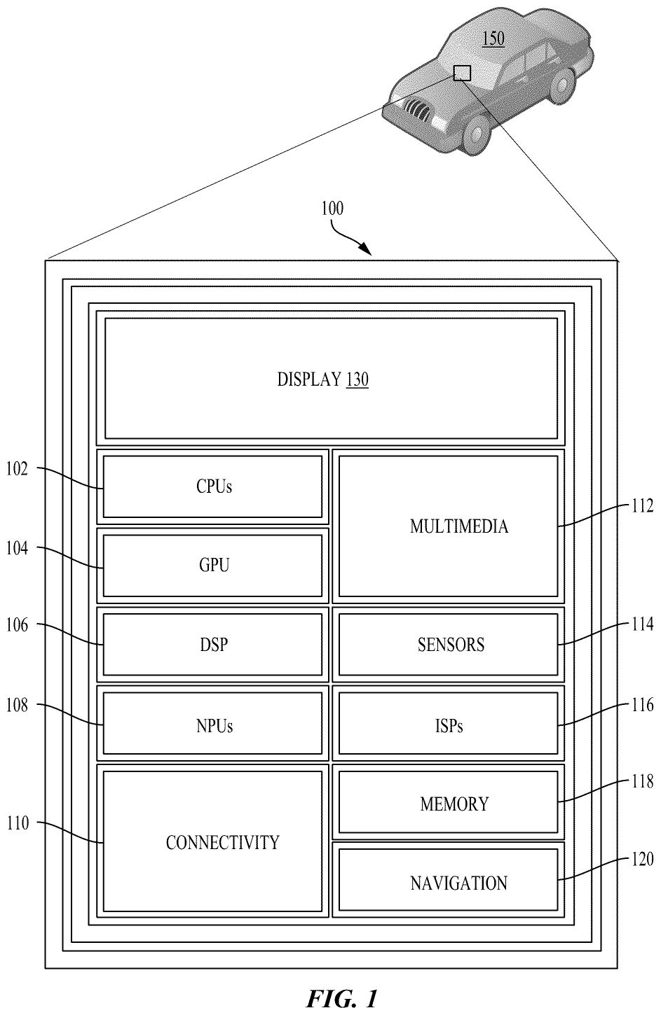

FIG. 1 illustrates an example implementation of the aforementioned system and method for a risk-biased trajectory prediction system using a system-on-a-chip (SOC) 100 of an autonomous vehicle 150. The SOC 100 may include a single processor or multi-core processors (e.g., a central processing unit (CPU) 102), in accordance with certain aspects of the present disclosure. Variables (e.g., neural signals and synaptic weights), system parameters associated with a computational device (e.g., neural network with weights), delays, frequency bin information, and task information may be stored in a memory block. The memory block may be associated with a neural processing unit (NPU) 108, a CPU 102, a graphics processing unit (GPU) 104, a digital signal processor (DSP) 106, a dedicated memory block 118, or may be distributed across multiple blocks. Instructions executed at a processor (e.g., CPU 102) may be loaded from a program memory associated with the CPU 102 or may be loaded from the dedicated memory block 118.

The SOC 100 may also include additional processing blocks configured to perform specific functions, such as the GPU 104, the DSP 106, and a connectivity block 110, which may include fifth generation (5G) cellular network technology, fourth generation long term evolution (4G LTE) connectivity, unlicensed WiFi connectivity, USB connectivity, Bluetooth® connectivity, and the like. In addition, a multimedia processor 112 in combination with a display 130 may, for example, apply a risk-biased component to forecast future agent trajectories, according to the display 130 illustrating a view of a vehicle. In some aspects, the NPU 108 may be implemented in the CPU 102, DSP 106, and/or GPU 104. The SOC 100 may further include a sensor processor 114, image signal processors (ISPs) 116, and/or navigation 120, which may, for instance, include a global positioning system.

The SOC 100 may be based on an Advanced RISC Machine (ARM) instruction set or the like. In another aspect of the present disclosure, the SOC 100 may be a server computer in communication with the autonomous vehicle 150. In this arrangement, the autonomous vehicle 150 may include a processor and other features of the SOC 100. In this aspect of the present disclosure, instructions loaded into a processor (e.g., CPU 102) or the NPU 108 of the autonomous vehicle 150 may include program code to forecast a risk-biased trajectories of agent surrounding an ego vehicle based on images processed by the sensor processor 114.

The instructions loaded into a processor (e.g., CPU 102) may also include program code to sample a latent space generated by a trained encoder of a generative network based on past surrounding agent trajectories. The instructions loaded into a processor (e.g., CPU 102) may also include program code to decode, based on the sampling of the latent space, risk-neutral future surrounding agent trajectories using a trained decoder of the generative network. The instructions loaded into a processor (e.g., CPU 102) may also include program code to sample a risk-biased latent space distribution generated by a trained, risk-aware encoder of the generative network based on past and/or future ego vehicle trajectories and a risk-sensitivity. The instructions loaded into a processor (e.g., CPU 102) may also include program code to predict, based on the sampling of the risk-biased latent space, risk-biased future surrounding agent trajectories using the trained decoder of the generative network.

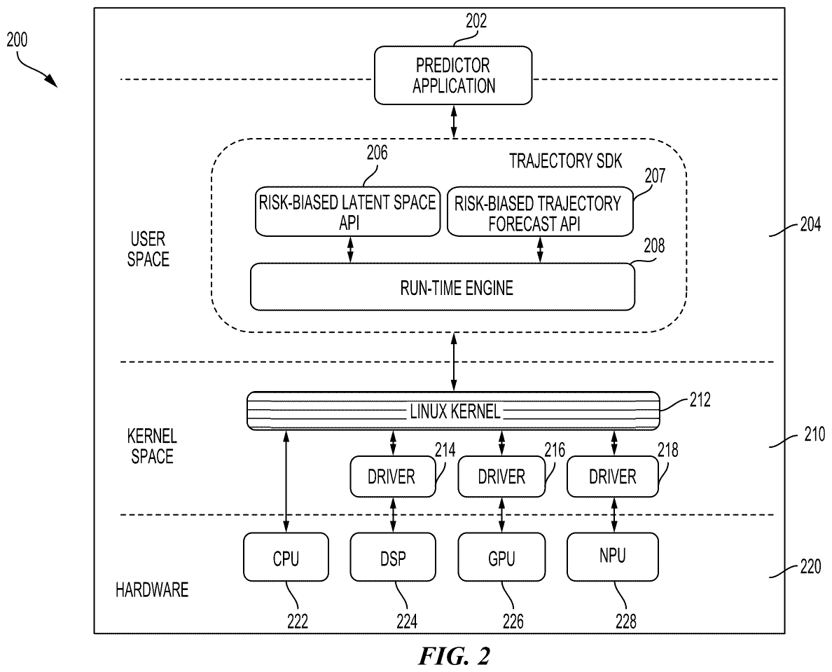

FIG. 2 is a block diagram illustrating a software architecture 200 that may modularize artificial intelligence (AI) functions for risk-biased trajectory prediction, according to aspects of the present disclosure. Using the architecture, a predictor application 202 may be designed such that it may cause various processing blocks of a system-on-a-chip (SOC) 220 (for example a CPU 222, a DSP 224, a GPU 226, and/or an NPU 228) to perform supporting computations during run-time operation of the predictor application 202. While FIG. 2 describes the software architecture 200 for selecting a vehicle control action of an autonomous agent to perform and follow a selected trajectory, it should be recognized that vehicle action control functionality is not limited to autonomous agents. According to aspects of the present disclosure, vehicle trajectory planning functionality is applicable to any vehicle type, provided the vehicle is equipped with appropriate machine learning functions.

The predictor application 202 may be configured to call functions defined in a user space 204 that may, for example, provide risk-biased trajectory forecasting services. The predictor application 202 may request to compile program code associated with a library defined in a risk-biased latent space application programming interface (API) 206. In these aspects of the present disclosure, the risk-biased latent space API 206 supports sampling of a risk-biased latent space distribution generated by a trained, risk-aware encoder of the generative network based past ego vehicle trajectories and a risk-sensitivity. In some aspects of the present disclosure, a trained decoder of the generative network decodes risk-neutral future surrounding agent trajectories based on the sampling of the latent space generated by a trained encoder of a generative network based on past surrounding agent trajectories.

The predictor application 202 may request to compile program code associated with a library defined in a risk-biased trajectory forecast API 207. In these aspects of the present disclosure, the risk-biased trajectory forecast API 207 predicts, based on the sampling of the risk-biased latent space, risk-biased future surrounding agent trajectories using the trained decoder of the generative network. These aspects of the present disclosure can achieve enhanced safety by simply replacing a conventional probabilistic motion forecaster with the proposed risk-biased model, while still using the same existing risk-neutral planner. This capability is intended for use in robotic applications, in which misestimating of risk could lead to injury, including autonomous vehicles and home robots that operate safely in close proximity to humans.

A run-time engine 208, which may be compiled code of a runtime framework, may be further accessible to the predictor application 202. The predictor application 202 may cause the run-time engine 208, for example, to take actions for predicting future agent. When an ego vehicle enters a traffic environment, the run-time engine 208 may in turn send a signal to an operating system 210, such as a Linux Kernel 212, running on the SOC 220. FIG. 2 illustrates the Linux Kernel 212 as software architecture for risk-biased trajectory forecasting to improve planning of an autonomous agent using a generative network. It should be recognized, however, aspects of the present disclosure are not limited to this exemplary software architecture. For example, other kernels may be used to provide the software architecture to support risk-biased trajectory forecasting functionality.

The operating system 210, in turn, may cause a computation to be performed on the CPU 222, the DSP 224, the GPU 226, the NPU 228, or some combination thereof. The CPU 222 may be accessed directly by the operating system 210, and other processing blocks may be accessed through a driver, such as drivers 214-218 for the DSP 224, for the GPU 226, or for the NPU 228. In the illustrated example, the deep neural network may be configured to run on a combination of processing blocks, such as the CPU 222 and the GPU 226, or may be run on the NPU 228, if present.

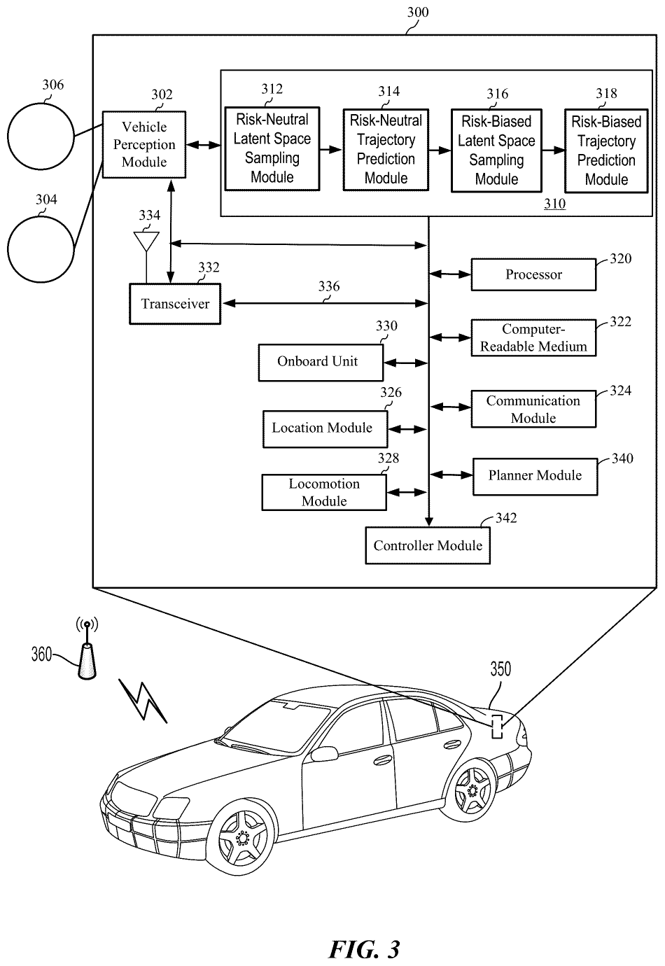

FIG. 3 is a diagram illustrating an example of a hardware implementation for a risk-biased trajectory predictor system 300, according to aspects of the present disclosure. The risk-biased trajectory predictor system 300 may be configured for improved trajectory forecasting for surrounding agents of an ego vehicle, such as a car 350. The risk-biased trajectory predictor system 300 may be a component of a vehicle, a robotic device, or other autonomous device (e.g., autonomous vehicles, ride-share cars, etc.). For example, as shown in FIG. 3, the risk-biased trajectory predictor system 300 is a component of the car 350.

Aspects of the present disclosure are not limited to the risk-biased trajectory predictor system 300 being a component of the car 350. Other devices, such as a bus, motorcycle, or other like autonomous vehicle, are also contemplated for implementing the risk-biased trajectory predictor system 300. In this example, the car 350 may be autonomous or semi-autonomous; however, other configurations for the car 350 are contemplated, such as an advanced driver assistance system (ADAS).

The risk-biased trajectory predictor system 300 may be implemented with an interconnected architecture, represented generally by an interconnect 336. The interconnect 336 may include any number of point-to-point interconnects, buses, and/or bridges depending on the specific application of the risk-biased trajectory predictor system 300 and the overall design constraints. The interconnect 336 links together various circuits including one or more processors and/or hardware modules, represented by a vehicle perception module 302, a predictor module 310, a processor 320, a computer-readable medium 322, a communication module 324, a location module 326, a locomotion module 328, an onboard unit 330, a planner module 340, and a controller module 342. The interconnect 336 may also link various other circuits such as timing sources, peripherals, voltage regulators, and power management circuits, which are well known in the art, and therefore, will not be described any further.

The risk-biased trajectory predictor system 300 includes a transceiver 332 coupled to the vehicle perception module 302, the predictor module 310, the processor 320, the computer-readable medium 322, the communication module 324, the location module 326, the locomotion module 328, the onboard unit 330, the planner module 340, and the controller module 342. The transceiver 332 is coupled to antenna 334. The transceiver 332 communicates with various other devices over a transmission medium. For example, the transceiver 332 may receive commands via transmissions from a user or a connected vehicle. In this example, the transceiver 332 may receive/transmit vehicle-to-vehicle traffic state information for the predictor module 310 to/from connected vehicles within the vicinity of the car 350.

The risk-biased trajectory predictor system 300 includes the processor 320 coupled to the computer-readable medium 322. The processor 320 performs processing, including the execution of software stored on the computer-readable medium 322 to provide risk-biased trajectory forecasting functionality according to the disclosure. The software, when executed by the processor 320, causes the risk-biased trajectory predictor system 300 to perform the various functions described for forecasting risk-biased future surrounding agent trajectories relative to the car 350, or any of the modules (e.g., 302, 310, 324, 326, 328, 340, and/or 342). The computer-readable medium 322 may also be used for storing data that is manipulated by the processor 320 when executing the software.

The vehicle perception module 302 may obtain measurements via different sensors, such as a first sensor 306 and a second sensor 304. The first sensor 306 may be a vision sensor (e.g., a stereoscopic camera or a red-green-blue (RGB) camera) for capturing 2D images. The second sensor 304 may be a ranging sensor, such as a light detection and ranging (LiDAR) sensor or a radio detection and ranging (RADAR) sensor. Of course, aspects of the present disclosure are not limited to the aforementioned sensors as other types of sensors (e.g., thermal, sonar, and/or lasers) are also contemplated for either of the first sensor 306 or the second sensor 304.

The measurements of the first sensor 306 and the second sensor 304 may be processed by the processor 320, the vehicle perception module 302, the predictor module 310, the communication module 324, the location module 326, the locomotion module 328, the onboard unit 330, the planner module 340, and/or the controller module 342. In conjunction with the computer-readable medium 322, the measurements of the first sensor 306 and the second sensor 304 are processed to implement the functionality described herein. In one configuration, the data captured by the first sensor 306 and the second sensor 304 may be transmitted to a connected vehicle via the transceiver 332. The first sensor 306 and the second sensor 304 may be coupled to the car 350 or may be in communication with the car 350.

The location module 326 may determine a location of the car 350. For example, the location module 326 may use a global positioning system (GPS) to determine the location of the car 350. The location module 326 may implement a dedicated short-range communication (DSRC)-compliant GPS unit. A DSRC-compliant GPS unit includes hardware and software to make the car 350 and/or the location module 326 compliant with one or more of the following DSRC standards, including any derivative or fork thereof: EN 12253:2004 Dedicated Short-Range Communication—Physical layer using microwave at 5.8 GHz (review); EN 12795:2002 Dedicated Short-Range Communication (DSRC)—DSRC Data link layer: Medium Access and Logical Link Control (review); EN 12834:2002 Dedicated Short-Range Communication—Application layer (review); EN 13372:2004 Dedicated Short-Range Communication (DSRC)—DSRC profiles for RTTT applications (review); and EN ISO 14906:2004 Electronic Fee Collection—Application interface.

The communication module 324 may facilitate communications via the transceiver 332. For example, the communication module 324 may be configured to provide communication capabilities via different wireless protocols, such as 5G, Wi-Fi, long term evolution (LTE), 4G, 3G, etc. The communication module 324 may also communicate with other components of the car 350 that are not modules of the risk-biased trajectory predictor system 300. The transceiver 332 may be a communications channel through a network access point 360. The communications channel may include DSRC, LTE, LTE-D2D, mmWave, Wi-Fi (infrastructure mode), Wi-Fi (ad-hoc mode), visible light communication, TV white space communication, satellite communication, full-duplex wireless communications, or any other wireless communications protocol such as those mentioned herein.

In some configurations, the network access point 360 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communications, mmWave, Wi-Fi (infrastructure mode), Wi-Fi (ad-hoc mode), visible light communication, TV white space communication, and satellite communication. The network access point 360 may also include a mobile data network that may include 3G, 4G, 5G NR, 6G, LTE, LTE-V2X, LTE-D2D, VOLTE, or any other mobile data network or combination of mobile data networks. Further, the network access point 360 may include one or more IEEE 802.11 wireless networks.

The risk-biased trajectory predictor system 300 also includes the planner module 340 and the controller module 342 for planning a route and controlling the locomotion of the car 350, via the locomotion module 328 for autonomous operation of the car 350. In one configuration, the controller module 342 may override a user input when the user input is expected (e.g., predicted) to cause a collision according to an autonomous level of the car 350. The modules may be software modules running in the processor 320, resident/stored in the computer-readable medium 322, and/or hardware modules coupled to the processor 320, or some combination thereof.

The National Highway Traffic Safety Administration (“NHTSA”) has defined different “levels” of autonomous vehicles (e.g., Level 0, Level 1, Level 2, Level 3, Level 4, and Level 5). For example, if an autonomous vehicle has a higher level number than another autonomous vehicle (e.g., Level 3 is a higher level number than Levels 2 or 1), then the autonomous vehicle with a higher level number offers a greater combination and quantity of autonomous features relative to the vehicle with the lower level number. These different levels of autonomous vehicles are described briefly below.

Level 0: In a Level 0 vehicle, the set of advanced driver assistance system (ADAS) features installed in a vehicle provide no vehicle control, but may issue warnings to the driver of the vehicle. A vehicle which is Level 0 is not an autonomous or semi-autonomous vehicle.

Level 1: In a Level 1 vehicle, the driver is ready to take driving control of the autonomous vehicle at any time. The set of ADAS features installed in the autonomous vehicle may provide autonomous features such as: adaptive cruise control (“ACC”); parking assistance with automated steering; and lane keeping assistance (“LKA”) type II, in any combination.

Level 2: In a Level 2 vehicle, the driver is obliged to detect objects and events in the roadway environment and respond if the set of ADAS features installed in the autonomous vehicle fail to respond properly (based on the driver's subjective judgement). The set of ADAS features installed in the autonomous vehicle may include accelerating, braking, and steering. In a Level 2 vehicle, the set of ADAS features installed in the autonomous vehicle can deactivate immediately upon takeover by the driver.

Level 3: In a Level 3 ADAS vehicle, within known, limited environments (such as freeways), the driver can safely turn their attention away from driving tasks, but must still be prepared to take control of the autonomous vehicle when needed.

Level 4: In a Level 4 vehicle, the set of ADAS features installed in the autonomous vehicle can control the autonomous vehicle in all but a few environments, such as severe weather. The driver of the Level 4 vehicle enables the automated system (which is comprised of the set of ADAS features installed in the vehicle) only when it is safe to do so. When the automated Level 4 vehicle is enabled, driver attention is not required for the autonomous vehicle to operate safely and consistent within accepted norms.

Level 5: In a Level 5 vehicle, other than setting the destination and starting the system, no human intervention is involved. The automated system can drive to any location where it is legal to drive and make its own decision (which may vary based on the jurisdiction where the vehicle is located).

A highly autonomous vehicle (“HAV”) is an autonomous vehicle that is Level 3 or higher. Accordingly, in some configurations the car 350 is one of the following: a Level 1 autonomous vehicle; a Level 2 autonomous vehicle; a Level 3 autonomous vehicle; a Level 4 autonomous vehicle; a Level 5 autonomous vehicle; and an HAV.

The predictor module 310 may be in communication with the vehicle perception module 302, the processor 320, the computer-readable medium 322, the communication module 324, the location module 326, the locomotion module 328, the onboard unit 330, planner module 340, the controller module 342, and the transceiver 332. In one configuration, the predictor module 310 receives sensor data from the vehicle perception module 302. The vehicle perception module 302 may receive the sensor data from the first sensor 306 and the second sensor 304. According to aspects of the disclosure, the vehicle perception module 302 may filter the data to remove noise, encode the data, decode the data, merge the data, extract frames, or perform other functions. In an alternate configuration, the predictor module 310 may receive sensor data directly from the first sensor 306 and the second sensor 304 to determine, for example, input traffic data images.

In safety-critical and interactive control tasks, such as autonomous driving, an autonomous agent accounts for uncertainty of a future motion of surrounding humans. Contemporary approaches to safe human-agent interaction decompose the decision-making pipeline into the vehicle perception module 302, the predictor module 310, and the planner module 340. The predictor module 310, based on training data, first produces likely future trajectories of surrounding agents detected by the vehicle perception module 302, which are then consumed by the planner module 340 for computing safe actions of the car 350. Coupling the predictor module 310 with risk-sensitive planning for enhanced safety may be performed, in which the planner module 340 computes and reduces a risk measure of a planned trajectory based on probabilistic forecasts of human motion from the predictor module 310. A risk measure may be a function that maps a cost distribution to a deterministic real number, which lies between an expected cost and a worst-case cost.

Although combining data-driven forecasting and risk-sensitive planning may be effective, this approach has several limitations. First, accurate risk evaluation of candidate agent plans remains challenging due to inaccurate characterization of uncertainty in human behavior and finite-sampling from the predictor module 310. Although some existing methods promoting diversity of prediction may alleviate this issue, they are not explicitly designed for reliable risk estimation specified for agent planning. Second, endowing the planner module 340 with risk-sensitivity often involves non-trivial modifications to the internal optimization algorithm of the planner module 340 because the process of optimization can differ significantly between risk-neutral and risk-sensitive planning. This modification can be problematic, if, for example, an autonomy stack already has a dedicated and complex (e.g., risk-neutral) planner module 340 in use and cannot easily modify the internal optimization algorithms of the planner module 340.

To address the above limitations, some aspects of the present disclosure consider risk within the predictor module 310 rather than the planner module 340 of the car 350. These aspects of the present disclosure present a risk-biased trajectory forecasting framework, which provides a general approach to making a generative trajectory forecasting model risk-aware. In some aspects of the present disclosure, a disclosed method augments a pre-trained generative model with an additional encoding process. This modification changes the output of the prediction so that it purposefully and deliberately over-estimates the probability of dangerous trajectories. This “pessimistic” forecasting model gives distributional robustness to the planner module 340 against potential inaccuracies of the human behavior model, according to some aspects of the present disclosure.

As shown in FIG. 3, the predictor module 310 includes a risk-neutral latent space sampling module 312, a risk-neutral trajectory prediction module 314, a risk-biased latent space sampling module 316, and a risk-biased trajectory prediction module 318. The risk-neutral latent space sampling module 312, the risk-neutral trajectory prediction module 314, the risk-biased latent space sampling module 316, and the risk-biased trajectory prediction module 318 may be components of a same or different artificial neural network, such as a deep convolutional neural network (CNN). The predictor module 310 is not limited to a CNN and may include a deep recurrent neural network (RNN) or other like neural network. The predictor module 310 relies on the vehicle perception module 302, which receives a data stream from the first sensor 306 and/or the second sensor 304. The data stream may include a 2D RGB image from the first sensor 306 and LIDAR data points from the second sensor 304. The data stream may include multiple frames, such as image frames of traffic data.

The risk-neutral latent space sampling module 312 may be configured to sample a risk-neutral latent space generated by a trained encoder of a generative network based on past surrounding agent trajectories relative to the car 350. In these aspects of the present disclosure, the risk-neutral trajectory prediction module 314 is configured to predict, based on the sampling of the risk-neutral latent space, risk-neutral future surrounding agent trajectories using a trained decoder of the generative network. The risk-biased latent space sampling module 316 is configured to sample a risk-biased latent space distribution generated by a trained, risk-aware encoder of the generative network based on past and/or future ego vehicle trajectories and a risk-sensitivity.

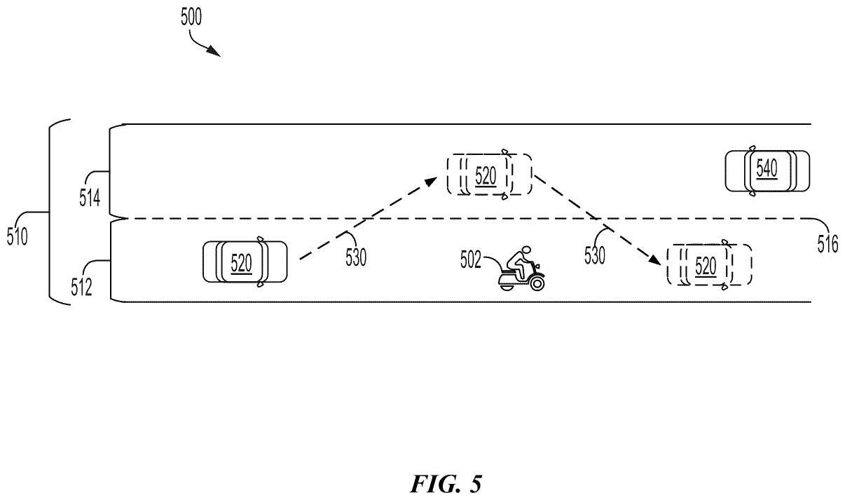

In some aspects of the present disclosure, the risk-biased trajectory prediction module 318 is configured to predict, based on the sampling of the risk-biased latent space, risk-biased future surrounding agent trajectories using the trained decoder of the generative network. Based on the predicted, risk-biased future surrounding agent trajectories, the planner module 340 plans an output trajectory of the car 350. Once the output trajectory of the car 350 is planned, a vehicle behavior of the car 350 may be controlled by the controller module 342 in a manner for motion planning and maneuvering of the car 350 by using the output trajectory to perform a driving maneuver, for example, as shown in FIG. 5.

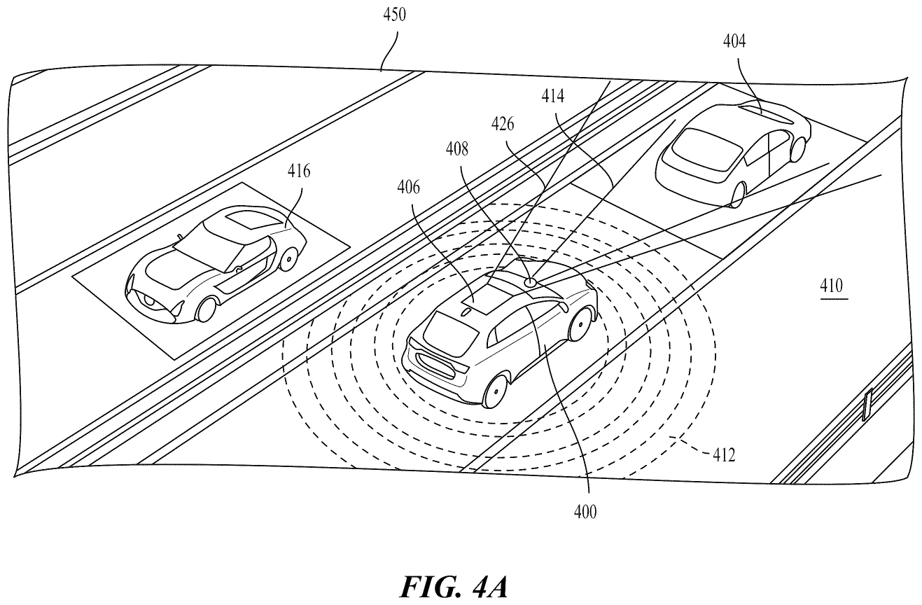

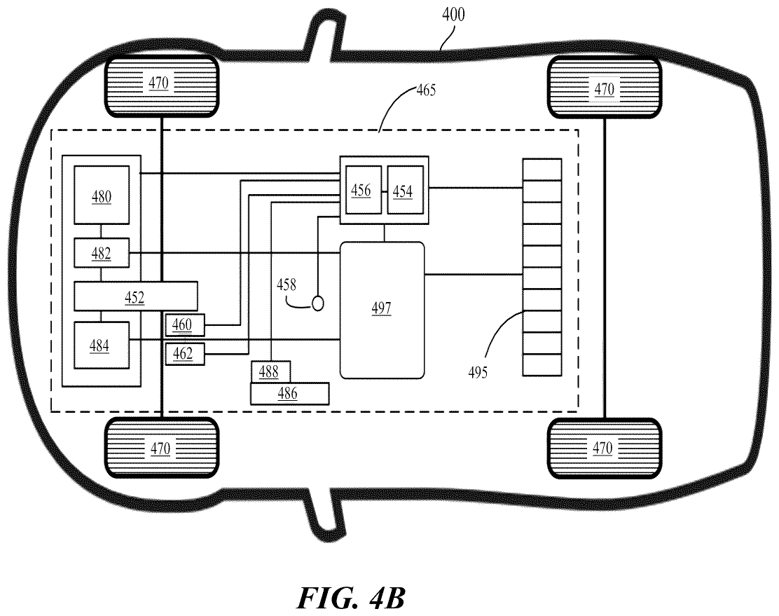

FIGS. 4A and 4B are block diagrams illustrating an example of a vehicle having a risk-biased trajectory predictor in an environment, in accordance with various aspects of the present disclosure. Various aspects of the present disclosure may be implemented in an agent, such as a vehicle. The vehicle may operate in either an autonomous mode, a semi-autonomous mode, or a manual mode. In some examples, the vehicle may switch between operating modes. FIG. 4A is a diagram illustrating an example of a vehicle 400 in an environment 450, in accordance with various aspects of the present disclosure.

In the example of FIG. 4A, the vehicle 400 may be an autonomous vehicle, a semi-autonomous vehicle, or a non-autonomous vehicle. As shown in FIG. 4A, the vehicle 400 may be traveling on a road 410. A first vehicle 404 may be ahead of the vehicle 400 and a second vehicle 416 may be adjacent to the vehicle 400. In this example, the vehicle 400 may include a 2D camera 408, such as a 2D red-green-blue (RGB) camera, and a LIDAR sensor 406. The 2D camera 408 and the LIDAR sensor 406 may be components of an overall sensor system 402. Other sensors, such as radar and/or ultrasound, are also contemplated. Additionally, or alternatively, although not shown in FIG. 4A, the vehicle 400 may include one or more additional sensors, such as a camera, a radar sensor, and/or a LIDAR sensor, integrated with the vehicle in one or more locations, such as within one or more storage locations (e.g., a trunk). Additionally, or alternatively, although not shown in FIG. 4A, the vehicle 400 may include one or more force measuring sensors.

In one configuration, the 2D camera 408 captures a 2D image that includes objects in the 2D camera 408 field of view 414 of the 2D camera 408. The LIDAR sensor 406 may generate one or more output streams. The first output stream may include a three-dimensional (3D) cloud point of objects in a first field of view, such as a 360° field of view 412 (e.g., bird's eye view). The second output stream 424 may include a 3D cloud point of objects in a second field of view, such as a forward facing field of view.

The 2D image captured by the 2D camera includes a 2D image of the first vehicle 404, as the first vehicle 404 is in the field of view 414 of the 2D camera 408. As is known to those of skill in the art, a LIDAR sensor 406 uses laser light to sense the shape, size, and position of objects in an environment. The LIDAR sensor 406 may vertically and horizontally scan the environment. In the current example, the artificial neural network (e.g., autonomous driving system) of the vehicle 400 may extract height and/or depth features from the first output stream. In some examples, an autonomous driving system of the vehicle 400 may also extract height and/or depth features from the second output stream.

The information obtained from the LIDAR sensor 406 and the camera 408 may be used to evaluate a driving environment. In some examples, the information obtained from the LIDAR sensor 406 and the camera 408 may identify whether the vehicle 400 is at an interaction or a crosswalk. Additionally, or alternatively, the information obtained from the LIDAR sensor 406 and the camera 408 may identify whether one or more dynamic objects, such as pedestrians, are near the vehicle 400.

FIG. 4B is a diagram illustrating an example of the vehicle 400 having a risk-biased planner, in accordance with various aspects of the present disclosure. It should be understood that various aspects of the present disclosure may be directed to an autonomous vehicle. The autonomous vehicle may be an internal combustion engine (ICE) vehicle, fully electric vehicle (EV), or another type of vehicle. The vehicle 400 may include drive force unit 465 and wheels 470. The drive force unit 465 may include an engine 480, motor generators (MGs) 482 and 484, a battery 495, an inverter 497, a brake pedal 486, a brake pedal sensor 488, a transmission 452, a memory 454, an electronic control unit (ECU) 456, a shifter 458, a speed sensor 460, and an accelerometer 462.

The engine 480 primarily drives the wheels 470. The engine 480 can be an ICE that combusts fuel, such as gasoline, ethanol, diesel, biofuel, or other types of fuels which are suitable for combustion. The torque output by the engine 480 is received by the transmission 452. MGs 482 and 484 can also output torque to the transmission 452. The engine 480 and MGs 482 and 484 may be coupled through a planetary gear (not shown in FIG. 4B). The transmission 452 delivers an applied torque to one or more of the wheels 470. The torque output by the engine 480 does not directly translate into the applied torque to the one or more wheels 470.

The MGs 482 and 484 can serve as motors which output torque in a drive mode, and can serve as generators to recharge the battery 495 in a regeneration mode. The electric power delivered from or to the MGs 482 and 484 passes through the inverter 497 to the battery 495. The brake pedal sensor 488 can detect pressure applied to the brake pedal 486, which may further affect the applied torque to the wheels 470. The speed sensor 460 is connected to an output shaft of the transmission 452 to detect a speed input which is converted into a vehicle speed by the ECU 456. The accelerometer 462 is connected to the body of the vehicle 400 to detect the actual deceleration of the vehicle 400, which corresponds to a deceleration torque.

The transmission 452 may be a transmission suitable for any vehicle. For example, the transmission 452 can be an electronically controlled continuously variable transmission (ECVT), which is coupled to the engine 480 as well as to the MGs 482 and 484. The transmission 452 can deliver torque output from a combination of the engine 480 and the MGs 482 and 484. The ECU 456 controls the transmission 452, utilizing data stored in the memory 454 to determine the applied torque delivered to the wheels 470. For example, the ECU 456 may determine that at a certain vehicle speed, engine 480 should provide a fraction of the applied torque to the wheels 470 while one or both of the MGs 482 and 484 provide most of the applied torque. The ECU 456 and the transmission 452 can control an engine speed (NE) of the engine 480 independently of the vehicle speed (V).

The ECU 456 may include circuitry to control the above aspects of vehicle operation. Additionally, the ECU 456 may include, for example, a microcomputer that includes one or more processing units (e.g., microprocessors), memory storage (e.g., RAM, ROM, etc.), and I/O devices. The ECU 456 may execute instructions stored in memory to control one or more electrical systems or subsystems in the vehicle. Furthermore, the ECU 456 can include one or more electronic control units such as, for example, an electronic engine control module, a powertrain control module, a transmission control module, a suspension control module, a body control module, and so on. As a further example, electronic control units may control one or more systems and functions such as doors and door locking, lighting, human-machine interfaces, cruise control, telematics, braking systems (e.g., anti-lock braking system (ABS) or electronic stability control (ESC)), or battery management systems, for example. These various control units can be implemented using two or more separate electronic control units, or a single electronic control unit.

The MGs 482 and 484 each may be a permanent magnet type synchronous motor including, for example, a rotor with a permanent magnet embedded therein. The MGs 482 and 484 may each be driven by an inverter controlled by a control signal from the ECU 456 so as to convert direct current (DC) power from the battery 495 to alternating current (AC) power, and supply the AC power to the MGs 482 and 484. In some examples, a first MG 482 may be driven by electric power generated by a second MG 484. It should be understood that in embodiments where MGs 482 and 484 are DC motors, no inverter is required. The inverter, in conjunction with a converter assembly may also accept power from one or more of the MGs 482 and 484 (e.g., during engine charging), convert this power from AC back to DC, and use this power to charge the battery 495 (hence the name, motor generator). The ECU 456 may control the inverter, adjust driving current supplied to the first MG 482, and adjust the current received from the second MG 484 during regenerative coasting and braking.

The battery 495 may be implemented as one or more batteries or other power storage devices including, for example, lead-acid batteries, lithium ion and nickel batteries, capacitive storage devices, and so on. The battery 495 may also be charged by one or more of the MGs 482 and 484, such as, for example, by regenerative braking or coasting during which one or more of the MGs 482 and 484 operates as a generator. Alternatively, or additionally, the battery 495 can be charged by the first MG 482, for example, when the vehicle 400 is idle (not moving/not in drive). Further still, the battery 495 may be charged by a battery charger (not shown) that receives energy from the engine 480. The battery charger may be switched or otherwise controlled to engage/disengage it with the battery 495. For example, an alternator or generator may be coupled directly or indirectly to a drive shaft of the engine 480 to generate an electrical current as a result of the operation of the engine 480. Still other embodiments contemplate the use of one or more additional motor generators to power the rear wheels of the vehicle 400 (e.g., in vehicles equipped with 4-Wheel Drive), or using two rear motor generators, each powering a rear wheel.

The battery 495 may also power other electrical or electronic systems in the vehicle 400. In some examples, the battery 495 can include, for example, one or more batteries, capacitive storage units, or other storage reservoirs suitable for storing electrical energy that can be used to power one or both of the MGs 482 and 484. When the battery 495 is implemented using one or more batteries, the batteries can include, for example, nickel metal hydride batteries, lithium ion batteries, lead acid batteries, nickel cadmium batteries, lithium ion polymer batteries, or other types of batteries.

The vehicle 400 may operate in one of an autonomous mode, a manual mode, or a semi-autonomous mode. In the manual mode, a human driver manually operates (e.g., controls) the vehicle 400. In the autonomous mode, an autonomous control system (e.g., autonomous driving system) operates the vehicle 400 without human intervention. In the semi-autonomous mode, the human may operate the vehicle 400, and the autonomous control system may override or assist the human. For example, the autonomous control system may override the human to prevent a collision or to obey one or more traffic rules.

FIG. 5 is a diagram illustrating an overview of a roadway environment, including an ego vehicle having a risk-biased trajectory predictor, according to aspects of the present disclosure. As shown in FIG. 5, a roadway environment 500 includes a roadway 510, having a first lane 512 and a second lane 514, in which a cycle 502 is in the first lane 512 and an oncoming vehicle 540 is in the second lane 514. An ego vehicle 520 is traveling in the first lane 512 and may plan for the ego vehicle 520 to cross a dashed center line 516 to change lanes from the first lane 512 to the second lane 514 and back to the first lane 512 to avoid the cycle 502, as shown by a trajectory 530. This trajectory 530, however, may lead to a collision with the oncoming vehicle 540 (e.g., an external road agent). In some aspects of the present disclosure, the ego vehicle 520 includes a risk-biased predictor to make risk-aware decisions for enabling robust planning. In this example, the ego vehicle 520, may be the vehicle 400, shown in FIGS. 4A and 4B.

Robust planning in interactive scenarios involves predicting the uncertain future to make risk-aware decisions. Unfortunately, due to long-tail safety-critical events, the risk is often under-estimated by finite-sampling approximations of probabilistic motion forecasts. This can lead to overconfident and unsafe agent behavior, even with robust planners. Instead of assuming full prediction coverage, some aspects of the present disclosure propose risk-aware prediction. Some aspects of the present disclosure introduce a new prediction objective to learn a risk-biased distribution over trajectories, so that risk evaluation simplifies to an expected cost estimation under a biased distribution. This reduces sample complexity during online planning for safe real-time performance.

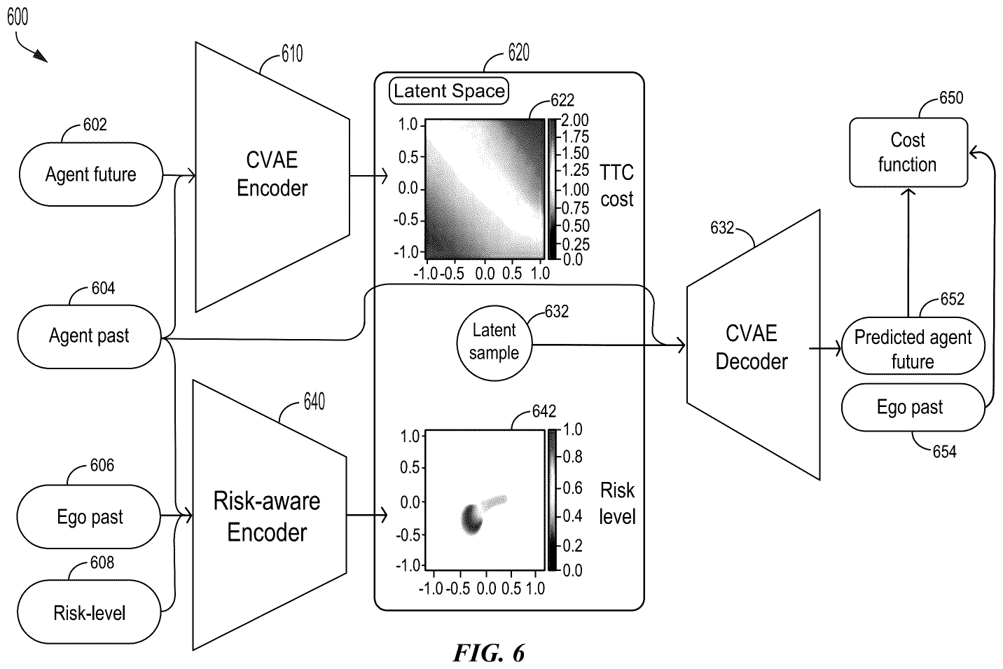

FIG. 6 is a diagram further illustrating the risk-biased trajectory predictor system of FIG. 3, according to aspects of the present disclosure. As shown in FIG. 6, the risk-biased trajectory predictor system 600 includes a conditional variational auto-encoder (CVAE) encoder 610 and a CVAE decoder 630. During an initial configuration, the CVAE encoder 610 encodes past agent trajectories 604 into a structured latent distribution 622 of a latent space 620. In addition, the CVAE decoder 630 is trained to determine the likelihood of an event occurring according to a cost function 650 associated with the possibility of a collision based on a predicted agent future trajectory 652 and an ego future trajectory 654, as follows. It should be recognized that our implementations for learning a generative model are also contemplated according to aspects of the present disclosure.

### Generative Probabilistic Trajectory Forecasting

As described, x and y refer to the past agent trajectories 604 and the future agent trajectories 602, and Y|ₓ denote the random variable of the future trajectory conditioned on the observed past trajectory x (e.g., the predicted agent future trajectory 652 (p(Y|ₓ))). These aspects of the present disclosure fit the distribution of p(Y|ₓ) given a dataset D) of independent and identically distributed samples of (x, y) pairs of the past agent trajectories 604 and the future agent trajectories 602. In this example, the distribution of p(Y|ₓ) is fit by maximizing the likelihood of future trajectories with respect to model parameters θ, ϕ: maximize_{θ,ϕ} [symbol] [symbol] (θ,ϕ;y|ₓ), where [symbol] (θ,ϕ;y|ₓ) is the likelihood of the sample y knowing x.

In some aspects of the present disclosure, a method to fit the distribution of p(Y|ₓ) learns the CVAE encoder 610, which produces the structured latent distribution 622 within the latent space 620. As further illustrated in FIG. 6, the CVAE decoder 630 conditions a likelihood estimation of the predicted agent future trajectory 652 on a latent random variable z|_{x,y} (e.g., a latent sample 632) with a posterior q_{ϕ}_{₂}(z|_{x,y}), or Z|ₓ with an inferred prior q_{ϕ}_{₁}(z|ₓ) used in the joint likelihood p_{θ}(y|ₓ,z|ₓ). In this example, the marginal likelihood of the future trajectory (or “model evidence”) is p_{θ}(y|_{x,z}), and is rewritten as:

$$ℒ ( θ , ϕ ; y {\vert}_{x} ) = \int {p}_{θ} ( y {\vert}_{x , z} ) dz = \int {p}_{θ} ( y {\vert}_{x , z} ) \frac{{q}_{{ϕ}_{2}} ( z {\vert}_{x , y} )}{{q}_{{ϕ}_{2}} ( z {\vert}_{x , y} )} dz = {𝔼}_{{q}_{{ϕ}_{2}} ( z {\vert}_{x , y} )} [ \frac{{p}_{θ} ( y {\vert}_{x} , z {\vert}_{x} )}{{q}_{{θ}_{2}} ( z {\vert}_{x , y} )} ] . \qquad ( 1 )$$

Using Jensen's inequality, the logarithm of Equation (1) is lower bounded by:

$$L ( θ , ϕ ; x , y ) = {𝔼}_{{q}_{{ϕ}_{2}} ( z {\vert}_{x , y} )} [ ln ( {p}_{θ} ( y {\vert}_{x , z} ) ) ] - KL ( {q}_{{ϕ}_{2}} ( z {\vert}_{x , y} ) ‖ {q}_{{ϕ}_{1}} ( z {\vert}_{x} ) ) , \qquad ( 2 )$$

As described, Equation (2) is referred to as the evidence lower bound (ELBO), in which q_{ϕ} and p_{θ} are modeled using neural networks. In some aspects of the present disclosure, the CVAE encoder 610 assumes a Gaussian prior with independent elements to produce the inferred prior ƒ_{ϕ}_{₁}:(x)→(μ|ₓ,diag(Σ|ₓ)), and the posterior ƒ_{ϕ}_{₂}:(x,y)→(μ|_{x,y},diag(Σ|_{x,y})). In these aspects of the present disclosure, the CVAE decoder 630 makes the forecast g_{θ}:(x,z)→y. In this example, each term in Equation (1) can be either computed or estimated with a Monte-Carlo sampling.

### Risk Measures

As described, a risk measure is defined as a function that maps a cost distribution (e.g., the cost function 650) to a real number. In other words, given a random cost variable C with distribution p, a risk measure of p yields a deterministic number r called the risk. In practice, a class of risk measures is considered that which lies between an expected value [symbol] [C] and a highest value sup(C). The former corresponds to the risk-neutral evaluation of C, while the latter gives the worst-case assessment. Such risk measures often take a user-specified risk-sensitivity level σ∈ [symbol] as an additional argument, which determines where the risk value r is positioned between [symbol] [C] and sup(C). In this example, a risk measure is defined as [symbol] ₚ:(C,σ)→r∈[ [symbol] [C], sup(C)], where the subscript p indicates that the risk is evaluated under the distribution p. Examples of such risk measures include entropic risk:

$${ℛ}_{p}^{entropic} ( C , σ ) = \frac{1}{σ} log {𝔼}_{p} [ exp ( σ C ) ]$$

as well as conditional value at risk (CVaR):

$${ℛ}_{p}^{C V a R} ( C , σ ) = \begin{matrix}inf \\ t ∈ ℝ\end{matrix} \{ t + \frac{1}{1 - σ} {𝔼}_{p} [ max ( 0 , C - t ) ] \} . \qquad ( 3 )$$

These aspects of the present disclosure assume that the CVaR of Equation (3) as the underlying risk measure, but note that the proposed approach is not necessarily bound to this particular choice. For CVaR, the risk value r given risk-sensitivity level σ∈(0,1) can be interpreted as the expected value of the right (1−σ)-tail of the cost distribution. Thus, [symbol] ₚ(C,σ) tends to [symbol] ₚ[C] as σ→0 and to sup(C) as σ→1.

One property of CVaR is its fundamental relation to distributional robustness. It is known that CVaR belongs to a class of risk measures called coherent measures of risk. This class of risk measures has the following dual characterization:

$${ℛ}_{p} ( C , σ ) = \begin{matrix}sup \\ q ∈\end{matrix} {𝔼}_{q} [ C ] , \qquad ( 4 )$$

where [symbol] is a uniquely-determined, non-empty and closed convex subset of the set of all density functions. This suggests that CVaR is equivalent to a worst-case expectation of the cost C when the underlying probability distribution q is chosen adversarially from [symbol] . Therefore, an autonomous robot optimizing CVaR (or coherent measures of risk in general) obtains distributional robustness, in that the objective accounts for robustness to potential inaccuracies in the underlying probabilistic model. In this context, the set [symbol] is often referred to as an ambiguity set.

For example, an agent incurs a cost C under a planned policy π trajectory. This cost is given by a cost function J^{π} such that C=J^{π}(Y) with Y being the human future trajectory random variable, which the agent predicts probabilistically. This example assumes that J^{π} is known and differentiable in y for each π. In an autonomous driving scenario, for example, the cost function 650 is designed so that J^{π}(y) is high when the agent collides into the particular trajectory Y=y of a human pedestrian.

Referring again to FIG. 6, the risk-biased trajectory predictor system 600 begins with a pre-trained generative model (e.g., the CVAE encoder 610) that provides a predictive distribution p(Y|ₓ)=∫p(Y|_{x,z})p(z)dz through an inferred latent distribution p(Z|ₓ) or a prior latent distribution p(Z), such as the structured latent distribution 622 within the latent space 620. In some aspects of the present disclosure, the CVAE decoder 630 maps the structured latent distribution 622 to a trajectory space using a generator (e.g., y=g(z,x)). In some aspects of the present disclosure, a generative model is used to learn the CVAE decoder 630 and the CVAE encoder 610 for the inference latent distribution p(Z|ₓ). The subscripts representing the network parameters are omitted, as they are assumed pre-trained and fixed throughout this description of various aspects of the present disclosure. Under this (unbiased) model, the risk is given by r= [symbol] ₚ(J^{π}(g(Z,x)),σ) using the risk measure introduced above.

Given the unbiased model and the risk measure, some aspects of the present disclosure are directed to finding another distribution q_{ψ}(Z) in the latent space 620 with learnable parameters ψ (e.g., a biased latent space distribution 642) under which simply taking the risk-neutral expectation of the cost yields the same risk value as given above. This can be achieved by enforcing he following equality constraint on this “biased” distribution q_{ψ}(Z):

[symbol]

_{q}_{_{ψ}}[J^{π}(g(Z,x))]= [symbol] ₚ(J^{π}(g(Z,x)),σ) (5)

Comparing both sides in Equation (5), it is noted that such q should be dependent on the risk-sensitivity level σ. These aspects of the present disclosure propose optimization of the parameters ψ of the risk-biased distribution q_{ψ}(Z|_{σ}). In general, many distributions q can satisfy Equation (5). These aspects of the present disclosure propose selecting a particular q that additionally minimizes the Kullback-Leibler (KL) divergence from the prior p, to prevent the biased distribution from becoming too different from the original unbiased distribution. This leads to the following constrained optimization problem:

$$\begin{matrix}minimize & KL\end{matrix} ( {q}_{ψ} ( Z {\vert}_{σ} ) ‖ p ( Z ) ) subject to {𝔼}_{{q}_{ψ}} [ {J}^{π} ( ℊ ( Z , x ) ) ] = {ℛ}_{p} ( {J}^{π} ( ℊ ( Z , x ) ) , σ ) . \qquad ( 6 )$$

### Connection to Importance Sampling

Under the assumption that the decoder g is volume preserving, the solution to the optimization problem of Equation (6) is unique. Volume preservation is a strong assumption that may not be met, but this uniqueness property is a good indication that the problem is well posed.

### Connection to Distributional Robustness

When a coherent measure of risk is chosen as an underlying risk measure (such as CVaR), the right-hand side of Equation (5) is equivalent to a worst-case distribution q chosen out of an ambiguity set [symbol] of Equation (4). In general, it is difficult to verify if the optimal distribution q_{ψ*} is in [symbol] , because the specifics of [symbol] depend on the choice of the risk measure as well as the risk-sensitivity level σ. Nevertheless, it holds true that any feasible distribution q_{ψ} for Equation (6) yields the same worst-case expected cost as the most adversarial distribution from [symbol] . Therefore, a planner relying on q_{ψ} instead of p will possess distributional robustness.

### Learning to Predict

As shown in FIG. 6, the methodology of the risk-biased trajectory predictor system 600 relies on the latent space 620 to bias the trajectory predictions, for example, according to a risk-biasing loss estimation process shown in Table 1. Although shown using the CVAE encoder 610 and the CVAE decoder 630, it should be recognized that the risk-biased trajectory predictor system 600 may be implemented more broadly to any predicting model that conditions on a latent sample.

TABLE 1

Proposed Risk-Biasing Loss Estimation Pseudocode
Process 1 Proposed Risk-Biasing Loss Estimation

INPUT: Trajectory (x, y)~ [symbol] , risk level σ~p(σ), KL-Loss weight β, risk weight α, ego motion
y_{ego}

| | |
|---|---|
| 1: | for k ∈ {1, . . . , K₁} do |
| 2: | Sample latent zₖ\|ₓ~ [symbol] (μ\|ₓ, Σ\|ₓ) with prior parameters (μ\|ₓ, Σ\|ₓ) = f_{ϕ}_{₁} (x) |
| 3: | Decode risk-neutral predictions yₖ = g_{θ}(x, zₖ\|ₓ) |
| 4: | Compute risk r using {y₁, . . . y_{K}_{₁}} and J^{y}^{^{ego}} with Monte Carlo estimation |
| 5: | for k ∈ {1, . . . K₂} do |
| 6: | Sample biased latent \hat{z}ₖ^{(b)}~ [symbol] (μ^{(b)}, Σ^{(b)}) with risk-biased parameters (μ^{(b)}, Σ^{(b)}) = |
| | f_{ψ}(x, σ, y_{robot}) |
| 7: | Decode risk-biased predictions ŷₖ = g_{θ} (x, \hat{z}ₖ^{(b)}) |
| 8: | $Compute expected cost \hat{r} = \frac{1}{{K}_{2}} {\sum }_{k = 1}^{{K}_{2}} {J}^{{y}_{ego}} ( {\hat{y}}_{k} )$ |
| 9: | Compute risk loss Lᵣᵢₛₖ = p(\hat{r} − r) and prior loss Lₚᵣᵢₒᵣ = |
| | KL ( [symbol] (μ^{(b)}, Σ^{(b)})\|\| [symbol] (μ\|ₓ, Σ\|ₓ)) |

OUTPUT: Loss value αLᵣᵢₛₖ + βLₚᵣᵢₒᵣ to train ψ (θ and ϕ₁ are fixed)

In some aspects of the present disclosure, the risk-biased trajectory predictor system 600 is composed of two multi-layer perceptron (MLP) encoders and one MLP decoder. An inference encoder takes the past trajectory x and outputs the parameters of a normal distribution μ|ₓ and log(diag(Σ|ₓ)). The posterior encoder takes the whole past and future trajectory x, y and outputs the parameters of a normal distribution μ|_{x,y} and log(diag(Σ|_{x,y})). Finally, the decoder takes the past trajectory x and a latent sample z and outputs a prediction y. In some aspects of the present disclosure, the risk-biased trajectory predictor system 600 is designed to model the interactions with both the other agents and map elements, including additional context inputs and larger hidden dimensions. The social and map interactions may be accounted for with a modified multi-context gating block.

### Learning to Bias Towards Risk

As shown in FIG. 6, the risk-biased trajectory predictor system 600 is configured to solve the problem of Equation (6) by learning a third neural network encoder (e.g., a risk-aware encoder 640) to define a biased latent space distribution 642 that, in combination with the pre-trained decoder (e.g., the CVAE decoder 630), produces biased forecasts. In some aspects of the present disclosure, the risk-aware encoder 640 (e.g., biased encoder) takes the past trajectory x (e.g., the past agent trajectories 604), a risk-level 608 (e.g., σ), and the ego future trajectory 654 (e.g., y_{ego}). In this configuration, the risk-aware encoder 640 outputs the parameters of a normal distribution μ^{(b)} and log(diag(Σ^{(b)})) to populate the biased latent space distribution 642.

In practice, optimizing a neural network under constraints is challenging. Therefore, the hard constraint of Equation (5) may be softened by using a penalty method, which progressively increases the weight α of the risk-loss during training. Some aspects of the present disclosure also leverage a user-defined sampling distribution p(σ) to sample different risk-sensitivity levels during training, so that the risk estimate remains accurate at any reasonable value of σ at inference time. Finally, the model of the risk-biased trajectory predictor system 600 is configured to overestimate the risk rather than underestimate the risk, such that scaling by the value s is performed and an asymmetric risk-loss is defined that penalizes linearly the underestimation of the risk and logarithmically its overestimation:

$$ρ ( x ) = \{ \begin{matrix}s \vert x \vert , & if x \leq 1 \\ log ( sx ) , & otherwise\end{matrix} . \qquad ( 7 )$$

These aspects of the present disclosure obtain the following loss function with α and β controlling the relative importance of the losses:

$$ℒ ( ψ ) = {𝔼}_{σ \sim p ( σ )} [ αρ ( {𝔼}_{{q}_{ψ}} [ {J}^{π} ( ℊ ( Z , x ) ) ] - {ℛ}_{p} ( {J}^{π} ( ℊ ( Z , x ) ) , σ ) ) + β KL ( {q}_{ψ} ( Z {\vert}_{σ , x} ) ‖ p ( Z {\vert}_{x} ) ) ]$$

The expected values and the risk measure are approximated by Monte Carlo sampling. For computing CVaR ( [symbol] ^{p}(g(Z,x)),σ), an estimator may be used. Consistency and asymptotic normality of this estimator should hold under mild assumptions.

As shown in Table 1, a risk-biased loss estimation process lays out the procedure for training the proposed risk-aware prediction, according to aspects of the present disclosure. This process relies on a fully trained CVAE with the CVAE encoder 610 (e.g., ƒ_{ϕ}_{₁}:x→(μ|ₓ,Σ|ₓ)) and the CVAE decoder 630 (e.g., g_{θ}:(x,z)→y) that fits the distribution of Y|ₓ from a dataset to form the structured latent distribution 622 of the latent space 620. In this example, the risk-aware encoder 640 is trained as a new latent-biasing encoder ƒ_{ψ}:x,σ,y_{robot}→(μ^{(b)},Σ^{(b)}) to bias the latent distribution and form the biased latent space distribution 642, while keeping the rest of the risk-biased trajectory predictor system 600 fixed. The risk-level σ is randomly sampled on [0,1] during training and chosen by the user at test time.

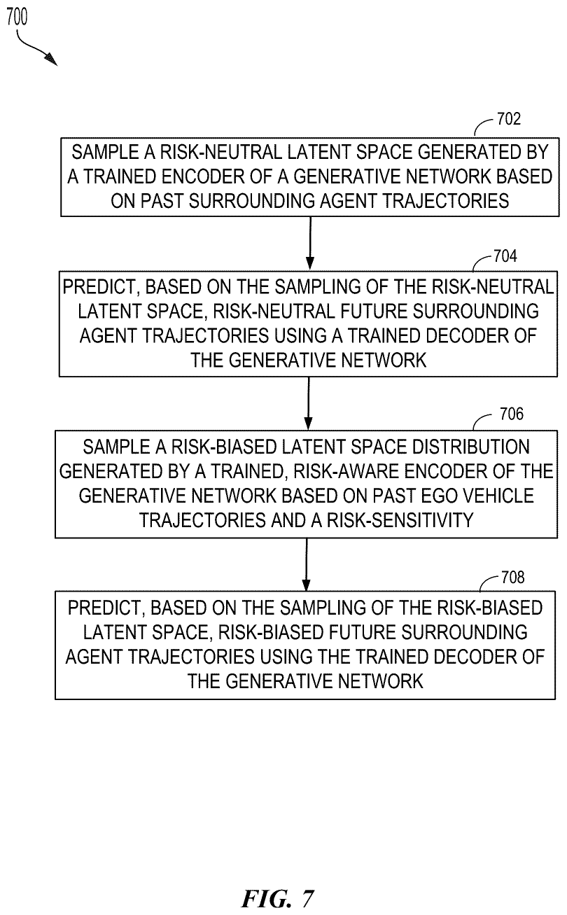

FIG. 7 is a flowchart illustrating a method for forecasting risk-biased trajectories of agents surrounding an ego vehicle, according to aspects of the present disclosure. A method 700 begins at block 702, in which a risk-neutral latent space generated by a trained encoder of a generative network based on past surrounding agent trajectories is sampled. For example, as shown in FIG. 6, the risk-biased trajectory predictor system 600 includes a conditional variational auto encoder (CVAE) encoder 610 and a CVAE decoder 630. During an initial configuration, the CVAE encoder 610 encodes past agent trajectories 604 into a structured latent distribution 622 of a latent space 620. As shown in Table 1, the structured latent distribution 622 of the latent space 620 is sampled at step 2.

At block 704, risk-neutral future surrounding agent trajectories using a trained decoder of the generative network, based on the sampling of the risk-neutral latent space, are predicted. For example, as shown in FIG. 6, the CVAE decoder 630 is trained to determine a risk-neutral probability of an event occurring according to a cost function 650 associated with the possibility of a collision based on the predicted agent future trajectory 652 and the ego future trajectory 654. As shown in Table 1, at step 3, risk-neutral predictions are decoded from the structured latent distribution 622 of the latent space 620 sampled at step 2 of Table 1.

At block 706, a risk-biased latent space distribution generated by a trained, risk-aware encoder of the generative network based on past ego vehicle trajectories and a risk-sensitivity is sampled. For example, as shown in FIG. 6, the risk-aware encoder 640 is trained as a new latent-biasing encoder ƒ_{ψ}:x,σ,y_{robot}→(μ^{(b)},Σ^{(b)}) to bias the latent distribution and form the biased latent space distribution 642, while keeping the rest of the risk-biased trajectory predictor system 600 fixed. In response, the CVAE decoder 630 samples the biased latent space distribution 642. As shown in Table 1, the structured latent distribution 622 of the latent space 620 is sampled at step 6.

At block 708, risk-biased future surrounding agent trajectories are predicted based on the sampling of the risk-biased latent space using the trained decoder of the generative network. For example, as shown in FIG. 6, the CVAE decoder 630 makes the forecast g_{θ}:(x,z)→y based on the sampling of the biased latent space distribution 642. As shown in Table 1, the structured latent distribution 622 of the latent space 620 is decoded to provide a predicted trajectory at step 7. As further illustrated in FIG. 6, the CVAE decoder 630 is trained to determine the likelihood of an event occurring according to the cost function 650 associated with the possibility of a collision based on the predicted agent future trajectory 652 and the ego future trajectory 654.

The method 700 further includes training the generative predictive model, including the encoder and the decoder, to determine the probability of an event occurring. The method 700 also includes fixing the decoder such that the decoder is no longer training. The method 700 further includes replacing the encoder with a risk-aware encoder. The method 700 also includes training the risk-aware encoder to emulate the encoder with an added constraint of risk estimation. The method 700 further includes operating a decoder (e.g., a CVAE decoder) to predict events with a focus on events that have a high cost or risk, for example, as shown in FIG. 6.

The method 700 further includes computing the expected cost by overestimating the probability of human motion when the expected cost of the human motion exceeds a predetermined value according to a current motion plan of the ego vehicle. The method 700 further includes predicting the risk-biased future surrounding agent trajectories by computing an expected cost associated with the predicted agent future trajectory and a predicted ego vehicle future trajectory. The method 700 also includes computing a risk loss based on the computed expected cost. The method 700 also includes computing a risk-biasing loss estimation based on the computed risk loss. The method 700 also includes computing the expected cost further by overestimating a probability of human motion when the expected cost of human motion exceeds a predetermined value according to a current motion plan of the ego vehicle.

In some aspects, the methods shown in FIG. 7 may be performed by the SOC 100 (FIG. 1) or the software architecture 200 (FIG. 2) of the autonomous vehicle 150. That is, each of the elements or method may, for example, but without limitation, be performed by the SOC 100, the software architecture 200, the processor (e.g., CPU 102) and/or other components included therein of the autonomous vehicle 150, or the risk-biased trajectory predictor system 300.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining, and the like. Additionally, “determining” may include receiving (e.g., receiving information), accessing (e.g., accessing data in a memory), and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules, and circuits described in connection with the present disclosure may be implemented or performed with a processor configured according to the present disclosure, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. The processor may be a microprocessor, but, in the alternative, the processor may be any commercially available processor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may connect a network adapter, among other things, to the processing system via the bus. The network adapter may implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Examples of processors that may be specially configured according to the present disclosure include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in various ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functions described throughout the present disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a non-transitory computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc, where disks usually reproduce data magnetically, while discs reproduce data optically with lasers. Thus, in some aspects computer-readable media may comprise non-transitory computer-readable media (e.g., tangible media). In addition, for other aspects, computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method of forecasting risk-biased trajectories of agents surrounding an ego vehicle, the method comprising:
sampling a risk-neutral latent space generated by a trained encoder of a generative network based on past surrounding agent trajectories;
predicting, based on the sampling of the risk-neutral latent space, risk-neutral future surrounding agent trajectories using a trained decoder of the generative network;
sampling a risk-biased latent space distribution generated by a trained, risk-aware encoder of the generative network based on past trajectories of the ego vehicle and a risk-sensitivity; and
predicting, based on the sampling of the risk-biased latent space distribution, risk-biased future surrounding agent trajectories using the trained decoder of the generative network.

2. The method of claim 1, further comprising training the risk-aware encoder of the generative network to learn the risk-biased latent space distribution based on past and/or future trajectories of the ego vehicle and the risk-sensitivity.

3. The method of claim 1 further comprising:
training a generative predictive model, including an encoder and a decoder, to determine a probability of an event occurring;
fixing the trained decoder such that the trained decoder is no longer training;
replacing the trained encoder with the risk-aware encoder;
training the risk-aware encoder to emulate the trained encoder with an added constraint of risk estimation; and
operating the trained decoder to predict events with a focus on the events that have a high cost or risk.

4. The method of claim 1, further comprising performing a vehicle control action to maneuver the ego vehicle according to the risk-biased future surrounding agent trajectories.

5. The method of claim 1, in which predicting the risk-biased future surrounding agent trajectories comprises:
computing an expected cost associated with a predicted agent future trajectory and a predicted ego vehicle future trajectory; and
computing a risk loss based on the computed expected cost; and
computing a risk-biasing loss estimation based on the computed risk loss.

6. The method of claim 5, in which computing the expected cost further comprises overestimating a probability of human motion when an expected cost of human motion exceeds a predetermined value according to a current motion plan of the ego vehicle.

7. The method of claim 1, in which a planner of the ego vehicle selects a reduced amount of prediction samples during prediction.

8. The method of claim 1, in which the trained encoder comprises a conditional variational auto-encoder (CVAE) encoder and the trained decoder comprises a CVAE decoder.

9. A non-transitory computer-readable medium having program code recorded thereon for forecasting risk-biased trajectories of agents surrounding an ego vehicle, the program code being executed by a processor and comprising:
program code to sample a risk-neutral latent space generated by a trained encoder of a generative network based on past surrounding agent trajectories;
program code to predict, based on the sampling of the risk-neutral latent space, risk-neutral future surrounding agent trajectories using a trained decoder of the generative network;
program code to sample a risk-biased latent space distribution generated by a trained, risk-aware encoder of the generative network based on past trajectories of the ego vehicle and a risk-sensitivity; and
program code to predict, based on the sampling of the risk-biased latent space distribution, risk-biased future surrounding agent trajectories using the trained decoder of the generative network.

10. The non-transitory computer-readable medium of claim 9, further comprising program code to train the risk-aware encoder of the generative network to learn the risk-biased latent space distribution based on past and/or future trajectories of the ego vehicle and the risk-sensitivity.

11. The non-transitory computer-readable medium of claim 9 further comprising:
training a generative predictive model, including an encoder and a decoder, to determine a probability of an event occurring;
fixing the trained decoder such that the trained decoder is no longer training;
replacing the trained encoder with the risk-aware encoder;
training the risk-aware encoder to emulate the trained encoder with an added constraint of risk estimation; and
operating the trained decoder to predict events with a focus on the events that have a high cost or risk.

12. The non-transitory computer-readable medium of claim 9, further comprising program code to perform a vehicle control action to maneuver the ego vehicle according to the risk-biased future surrounding agent trajectories.

13. The non-transitory computer-readable medium of claim 9, in which the program code to predict the risk-biased future surrounding agent trajectories comprises:
program code to compute an expected cost associated with a predicted agent future trajectory and a predicted ego vehicle future trajectory; and
program code to compute a risk loss based on the computed expected cost; and
program code to compute a risk-biasing loss estimation based on the computed risk loss.

14. The non-transitory computer-readable medium of claim 13, in which the program code to compute the expected cost further comprises program code to overestimate a probability of human motion when an expected cost of human motion exceeds a predetermined value according to a current motion plan of the ego vehicle.

15. The non-transitory computer-readable medium of claim 9, in which a planner of the ego vehicle selects a reduced amount of prediction samples during prediction.

16. The non-transitory computer-readable medium of claim 9, in which the trained encoder comprises a conditional variational auto-encoder (CVAE) encoder and the trained decoder comprises a CVAE decoder.

17. A system for forecasting risk-biased trajectories of agents surrounding an ego vehicle, the system comprising:
a risk-neutral latent space sampling module to sample a risk-neutral latent space generated by a trained encoder of a generative network based on past surrounding agent trajectories;
a risk-neutral trajectory prediction module to predict, based on the sampling of the risk-neutral latent space, risk-neutral future surrounding agent trajectories using a trained decoder of the generative network;
a risk-biased latent space sampling module to sample a risk-biased latent space distribution generated by a trained, risk-aware encoder of the generative network based on past trajectories of the ego vehicle and a risk-sensitivity; and
a risk-biased trajectory prediction module to predict, based on the sampling of the risk-biased latent space distribution, risk-biased future surrounding agent trajectories using the trained decoder of the generative network.

18. The system of claim 17, further comprising a controller module to perform a vehicle control action to maneuver the ego vehicle according to the risk-biased future surrounding agent trajectories.

19. The system of claim 17, further comprising a planner to selects a reduced amount of prediction samples during prediction.

20. The system of claim 17, in which the trained encoder comprises a conditional variational auto-encoder (CVAE) encoder and the trained decoder comprises a CVAE decoder.
